(19) United States
(12) Patent Application Publication
(10) Pub. No.: US 2011/0041179 A1
(43) Pub. Date: Feb. 17, 2011

(54) Malware detection

(75) Inventor: Mika STÅHLBERG, Espoo (FI)

Correspondence Address: HARRINGTON & SMITH, 4 RESEARCH DRIVE, Suite 202, SHELTON, CT, 06484-6212, US

(73) Assignee: F-Secure Oyj

(21) Appl. No.: 12/462,913

(22) Filed: Aug. 11, 2009

(51) Int. Cl. G06F 11/00

(52) U.S. Cl. 726/23

(57) ABSTRACT

According to a first aspect of the present invention there is provided a method of detecting potential malware. The method comprises, at a server, receiving a plurality of code samples, the code samples including at least one code sample known to be malware and at least one code sample known to be legitimate, executing each of the code samples in an emulated computer system, extracting bytestrings from any changes in the memory of the emulated computer system that result from the execution of each sample, using the extracted bytestrings to determine one or more rules for differentiating between malware and legitimate code, and sending the rule(s) to one or more client computers. At the or each client computer, for a given target code, executing the target code in an emulated computer system, extracting bytestrings from any changes in the memory of the emulated computer system that result from the execution of the target code, and applying the rule(s) received from the server to the extracted bytestrings to determine if the target code is potential malware.

### TECHNICAL FIELD

The present invention relates to a method of detecting potential malware programs.

### BACKGROUND

Malware is short for malicious software and is used as a term to refer to any software designed to infiltrate or damage a computer system without the owner's informed consent. Malware can include computer viruses, worms, trojan horses, rootkits, adware, spyware and any other malicious and unwanted software.

When a device is infected by malware, most often in the form of a program or other executable code, the user will often notice unwanted behaviour and degradation of system performance as the infection can create unwanted processor activity, memory usage, and network traffic. This can also cause stability issues leading to application or system-wide crashes. The user of an infected device may incorrectly assume that poor performance is a result of software flaws or hardware problems, taking inappropriate remedial action, when the actual cause is a malware infection of which they are unaware. Furthermore, even if a malware infection does not cause a perceptible change in the performance of a device, it may be performing other malicious functions such as monitoring and stealing potentially valuable commercial, personal and/or financial information, or hijacking a device so that it may be exploited for some illegitimate purpose.

Many end users make use of anti-virus software to detect and possibly remove malware. In order to detect a malware file, the anti-virus software must have some way of identifying it amongst all the other files present on a device. Typically, this requires that the anti-virus software has a database containing the “signatures” or “fingerprints” that are characteristic of individual malware program files. When the supplier of the anti-virus software identifies a new malware threat, the threat is analysed and its signature is generated. The malware is then “known” and its signature can be distributed to end users as updates to their local anti-virus software databases.

In order to evade these signature detection methods, malware authors design their software to hide the malware code from the anti-virus software. A relatively simple evasion technique is to encrypt or “pack” the malware such that the malware is only decrypted/unpacked at runtime. However, that part of the code providing the decryption or unpacking algorithm cannot be hidden, as it must be capable of being executed properly, such that it is possible that anti-virus software can be designed to identify these algorithms as a means of detection or, once identified, to use these algorithms to unpack the code prior to scanning for a signature.

An advance on this evasion technique is to make use of polymorphic malware programs. Polymorphic malware typically also rely on encryption to obfuscate the main body of the malware code, but are designed to modify the encryption/decryption algorithms and/or keys for each new replication, such that both the code and the decryption algorithm contain no recognisable signature that is consistent between infections. In addition, in order to make detection even more difficult, some polymorphic malware programs pack their code multiple times, each time using different algorithms and/or keys. However, these polymorphic malware programs will decrypt themselves when executed such that, by executing them in an isolated emulated environment or test system (sometimes referred to as a “sandbox”), their decrypted in-memory image can then be scanned for signatures.

So-called “metamorphic” malware programs also change their appearance to avoid detection by anti-malware software. Whilst polymorphic malware programs hide the main body of their code using encryption, metamorphic malware programs modify their code as they propagate. There are several techniques that can be employed by metamorphic malware programs to change their code. For example, these techniques can range from the insertion and removal of “garbage” instructions that have no effect on the function of the malware, to the replacement of entire blocks of logic with functionally equivalent blocks of logic. Whilst it can be very difficult to detect metamorphic malware using signatures, the mutation engine, i.e. those parts of the malware program code that act to transform the code, is included within the malware program files. As such, it is possible to analyse this code to develop signatures and behavioural models that can enable detection of this malware and its variants. However, such approaches for detecting metamorphic malware programs require highly skilled individuals to perform the analysis, which is difficult, time consuming and prone to failure.

A yet further advance on this detection evasion technique is server-side metamorphism, wherein the mutation engine responsible for transforming the malware into different variants does not reside within the malware code itself, but remotely on a server. As such, the mutation engine cannot easily be isolated and analysed to determine ways of detecting the variants. Furthermore, the malware designers can use techniques to hide the identity of the server distributing the mutated variants, such that the mutation engine is difficult to locate.

Signature scanning is of course only one of the “weapons” available to providers of anti-virus applications. For example, another approach, commonly used in parallel with signature scanning, is to use heuristics (that is rules) that describe suspicious behaviour, indicative of malware. For example, heuristics can be based on behaviours such as API calls, attempts to send data over the Internet, etc.

### SUMMARY

It is an object of the present invention to provide a process for detecting polymorphic and metamorphic malware that at least partially overcomes some of the problems described above.

According to a first aspect of the present invention there is provided a method of detecting potential malware. The method comprises, at a server, receiving a plurality of code samples, the code samples including at least one code sample known to be malware and at least one code sample known to be legitimate, executing each of the code samples in an emulated computer system, extracting bytestrings from any changes in the memory of the emulated computer system that result from the execution of each sample, using the extracted bytestrings to determine one or more rules for differentiating between malware and legitimate code, and sending the rule(s) to one or more client computers. At the or each client computer, for a given target code, executing the target code in an emulated computer system, extracting bytestrings from any changes in the memory of the emulated computer system that result from the execution of the target code, and applying the rule(s) received from the server to the extracted bytestrings to determine if the target code is potential malware.

This method of detecting malware does not require that the in-memory image of the executed code is not mutated; it relies on the fact that even mutated variants of a malware program will create identical in-memory bytestrings and memory structures.

The method may further comprise, at the server, storing the one or more rules, receiving an additional code sample, executing the additional code sample in an emulated computer system, extracting bytestrings from any changes in the memory of the emulated computer system that result from the execution of the additional code sample, using the extracted bytestrings to update the one or more stored rules, and sending the updated rules to the client computer.

The method may further comprise, at the server, gathering metadata associated with said extracted bytestrings, and using said metadata together with said extracted bytestrings to determine the one or more rules for differentiating between malware and legitimate code. The method may then further comprise, at the client computer, gathering metadata associated with said extracted bytestrings, and applying the rules received from the server to said bytestrings and associated metadata.

The metadata may further comprise one or more of:
the location of a bytestring in the memory;
the string in its encrypted or plaintext form;
the encoding of the bytestring;
the time or event at which the bytestring occurred;
the number of memory accesses to the bytestring;
the location of the function that created the bytestring;
the memory injection type used and the target process;
whether the bytestring was overwritten or the allocated memory de-allocated.

The one or more rules may comprise one or more combinations of bytestrings and/or metadata associated with bytestrings, the presence of which in the bytestrings and associated metadata extracted during execution of the target code is indicative of malware.

The bytestrings extracted from the memory of the emulated computer system may include bytestrings extracted from the heap and the stack sections of the memory.

The method may further comprise, at the server, extracting bytestrings written into files that are created on the disk of the emulated computer system by the sample code during execution in the emulated computer system. The method may then further comprise, at the or each client computer, extracting bytestrings written into files that are created on the disk of the emulated computer system by the target code during execution in the emulated computer system.

The method may further comprise, using decoy bytestrings in documents and when imitating user actions within the emulated environment, and identifying any decoy bytestrings extracted from the memory during execution of the sample or target code in the emulated computer system.

The method may further comprise, at the server, prior to determining one or more rules for differentiating between malware and legitimate code, removing from the extracted bytestrings any bytestrings that match those contained within a list of insignificant bytestrings.

The method may further comprise, at the server, prior to determining one or more rules for differentiating between malware and legitimate code, measuring the difference between each of the extracted bytestrings and bytestrings that have previously been identified as being associated with both malware and legitimate code, and removing from the extracted bytestrings any bytestrings for which this difference does not exceed a threshold.

The method may further comprise, at the or each client computer, prior to applying the rule(s) received from the server, removing from the extracted bytestrings any bytestrings that match those contained within a list of insignificant bytestrings.

The step of using the extracted bytestrings to determine one or more rules for differentiating between malware and legitimate code may comprise, at the server, providing the bytestrings to one or more artificial intelligence algorithms, the artificial intelligence algorithm(s) being configured to generate the one or more rules for differentiating between malware and legitimate code.

According to a second aspect of the present invention there is provided a method of detecting potential malware. The method comprises, at a server, receiving a plurality of code samples, the code samples including at least one sample known to be malware and at least one code sample known to be legitimate, executing each of the code samples in an emulated computer system, extracting bytestrings from changes in the memory of the emulated computer system that result from the execution of each sample, using the extracted bytestrings to determine one or more rules for differentiating between malware and legitimate code. At the or each client computer, for a given target code, executing the target code in an emulated computer system, extracting bytestrings from changes in the memory of the emulated computer system that result from the execution of the target code, and sending the extracted bytestrings to the server. At the server, applying the rule(s) to the extracted bytestrings received from the or each computer to determine if the target code is potential malware and sending the result to the or each computer.

According to a third aspect of the present invention there is provided a server for use in provisioning a malware detection service. The server comprises a receiver for receiving a plurality of code samples, the code samples including at least one sample known to be malware and at least one code sample known to be legitimate, a processor for executing each of the code samples in an emulated computer system, and for extracting bytestrings from changes in the memory of the emulated computer system that result from the execution of each sample, an analysis unit for using the bytestrings extracted from the or each code sample to determine one or more rules for differentiating between malware and legitimate code, and a transmitter for sending the rules to one or more client computers.

The server may also comprise a database for storing the one or more rules, wherein the receiver is further arranged to receive an additional code sample, the processor is further arranged to execute the additional code sample in an emulated computer system, to extract bytestrings from changes in the memory of the emulated computer system that result from the execution of the additional code sample, the analysis unit is further arranged to use the bytestrings extracted from the additional sample to update the one or more rules stored in the database, and the transmitter is further arranged to send the updated rules to the client computer.

The processor may be further arranged to gather metadata associated with said extracted bytestrings, and the analysis unit may be further arranged to use said metadata together with said extracted bytestrings to determine the one or more rules for differentiating between malware and legitimate code.

The one or more rules may comprise one or more combinations of bytestrings and/or metadata associated with bytestrings, the presence of which in the bytestrings and associated metadata extracted during execution of the target code is indicative of malware.

The he processor may be further arranged to extract bytestrings from the heap and the stack sections of the memory of the emulated computer system.

The processor may be further arranged to remove, from the extracted bytestrings, any bytestrings that match those contained within a list of insignificant bytestrings.

The analysis unit may be further arranged to implement one or more artificial intelligence algorithms, the artificial intelligence algorithm(s) being configured to generate the one or more rules for differentiating between malware and legitimate code.

According to a fourth aspect of the present invention there is provided a client computer. The client computer comprises a receiver for receiving from a server one or more rules for differentiating between malware and legitimate code, a memory for storing the one or more rules, and a malware detection unit for executing a target code in an emulated computer system, for extracting bytestrings from changes in the memory of the emulated computer system that result from the execution of each sample, and applying said one or more rules received from the server to the extracted bytestrings to determine if the target code is potential malware.

The malware detection unit may be further arranged to extract bytestrings from the heap and the stack sections of the memory of the emulated computer system.

The malware detection unit may be further arranged to gather metadata associated with said extracted bytestrings from the memory during execution of the target code, and to apply the rules received from the server to said bytestrings and their associated metadata.

The malware detection unit may be further arranged to remove, from the extracted bytestrings, any bytestrings that match those contained within a list of insignificant bytestrings, prior to applying the rule(s) received from the server.

### BRIEF DESCRIPTION OF THE DRAWINGS

FIG. 1 illustrates schematically a system for detecting malware according to an embodiment of the present invention; and

FIG. 2 is a flow diagram illustrating the process of detecting malware according to an embodiment of the present invention.

### DETAILED DESCRIPTION

In order to at least partially overcome some of the problems described above, it is proposed here to execute samples of malware code and “clean” or benign code in an emulated environment, extract bytestrings (strings in which the stored data does not necessarily represent text) from the image of the code in the memory of the emulated environment and use these extracted bytestrings to develop heuristic logic that can be used to differentiate between malware code and clean code. This method does not require that the in-memory image is not mutated; it relies on the fact that even mutated variants of a malware program will create identical in-memory bytestrings and memory structures. Furthermore, the extracted strings can be used to train machine learning or artificial intelligence algorithms to develop the heuristic logic, in the form of mathematical models, which can then be used to classify some target code either as clean or as potential malware. The use of artificial intelligence algorithms to develop this malware detection logic provides that the system can be automated, thereby reducing the time taken to analyse the continually increasing numbers of malware programs.

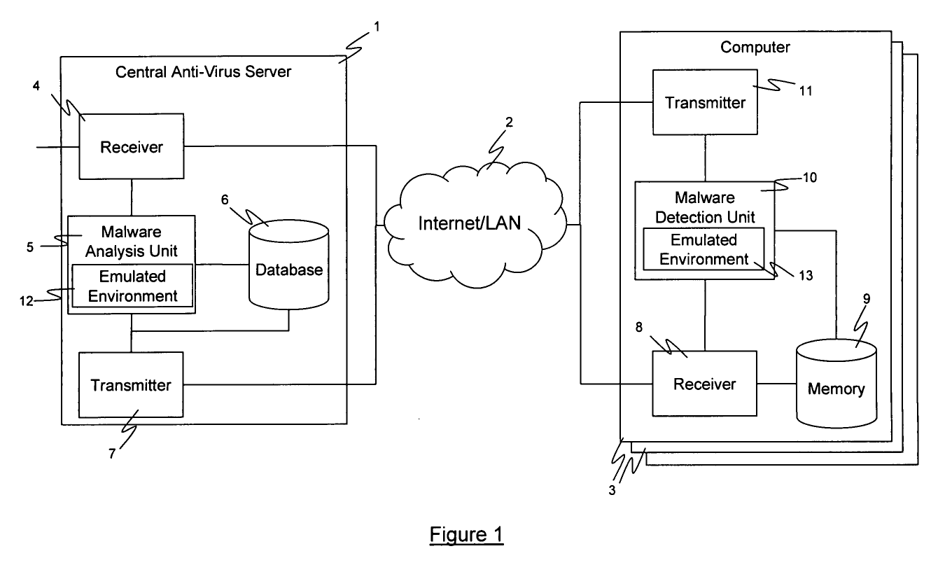

FIG. 1 illustrates schematically a system according to an embodiment of the present invention and which comprises a central anti-virus server 1 connected to a network 2 such as the Internet or a LAN. Also connected to the network are a plurality of end user computers 3. The central anti-virus server 1 is typically operated by the provider of some malware detection software that is run on each of the computers 3, and the users of these computers will usually be subscribers to an update service supplied by the central anti-virus server 1. Alternatively, the central anti-virus server 1 may be that of a network administrator or supervisor, each of the computers 3 being part of the network for which the supervisor is responsible. The central anti-virus server 1 comprises a receiver 4, an analysis unit 5, a database 6 and a transmitter 7. Each of the computers 3 comprises a receiver 8, a memory 9, a malware detection unit 10 and a transmitter 11. The computers 3 may be a desktop personal computer (PC), laptop, personal data assistant (PDA) or mobile phone, or any other suitable device.

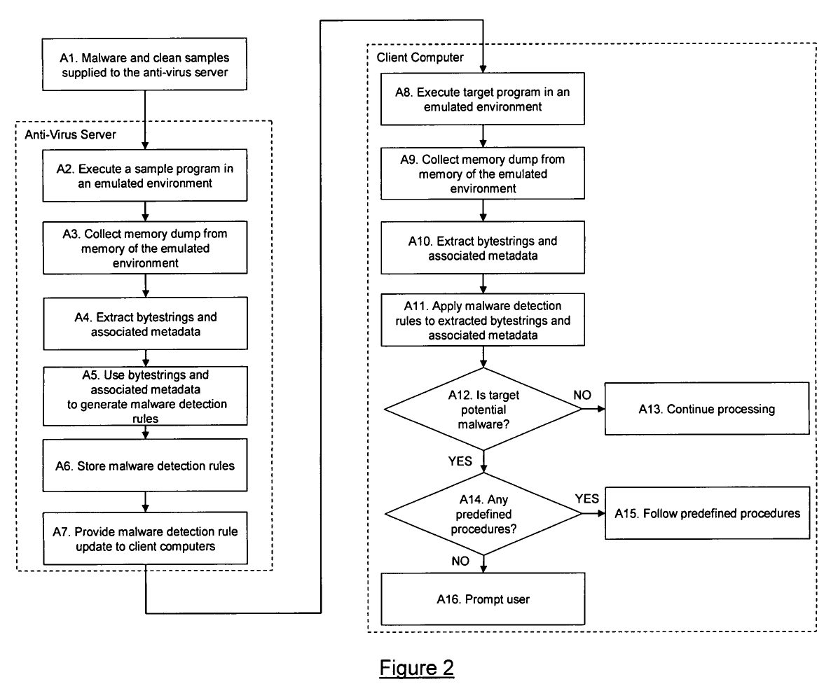

FIG. 2 is a flow diagram further illustrating the process of detecting malware according to an embodiment of the present invention. The steps performed are as follows:
A1. Samples of malware code and clean code are supplied to the central anti-virus server 1.
A2. For each of these samples, the analysis unit 5 executes the sample code in an emulated environment or “goat” test system 12. The analysis unit 5 is also informed as to whether the sample is that of malware or clean code.
A3. During execution of the sample the analysis unit 5 collects snapshots or dumps of any changes in the memory of the emulated environment that occur due to execution of the sample code.
A4. The analysis unit 5 then extracts any bytestrings (strings in which the stored data does not necessarily represent text) from within these memory dumps and records any metadata associated with those bytestrings. The analysis unit 5 may also performing filtering of the extracted bytestrings to remove any bytestrings it determines to be insignificant. The analysis unit 5 may also identify any extracted bytestrings or types of bytestrings that are considered to be of particular relevance and flag these, or may add a weighting for any bytestrings or types of bytestrings that are considered to be significant indicators of malware.
A5. Once the analysis unit 5 has a number of samples it uses this information, together with the information that identifies each of the associated sample as being either malware or clean, to learn how to identify patterns that are indicative of a malware program and to develop logic that can be applied for their detection. This learning can be achieved using artificial intelligence (Al) or machine learning techniques, and may take into account any flags and/or weightings that have been associated with the extracted bytestrings.
A6. This logic is stored in the database 6 and can be continually updated or modified as the analysis unit 5 analyses more samples.
A7. This logic, or a subset of this logic, is then provided to the computers 3 in the form of updates. For example, these updates can be provided in the form of uploads from the central anti-virus server 1 accessed over the network. These updates can occur as part of a regular schedule or in response to a particular event, such as the generation of some new logic, a request by a user, or upon the identification of a new malware program.
A8. In order to make use of this logic when performing a malware scan, the malware detection unit 10 of a computer 3 executes the code that is the target of the scan in emulated environment or test system 13 (otherwise known as a sandbox). This scan can be performed on-demand or on-access.
A9. During execution of the target code the malware detection unit 10 collects snapshots or dumps of any changes in the memory of the test system that occur due to execution of the target code.
A10. The malware detection unit 10 then extracts any bytestrings from within these memory dumps and records any metadata associated with those bytestrings. The malware detection unit 10 may also performing filtering of the extracted bytestrings to remove any bytestrings it determines to be insignificant.
A11. The malware detection unit 10 then applies the logic provided by central anti-virus server 1 to the extracted bytestrings and their metadata.
A12. The application of the malware detection logic determines if the target program is potential malware.
A13. If, according to the malware detection logic, the extracted bytestrings and/or their metadata do not indicate that the target code is likely to be malware, then the computer 3 can continue to process the code according to standard procedures.
A14. If, according to the malware detection logic, the extracted bytestrings and/or their metadata do indicate that the target code is likely to be malware, then the malware detection unit 10 will check if there are any predefined procedures, in the form of a user-definable profile or centrally administered policy, for handling such suspicious code.
A15. If there are some predefined procedures, then the malware detection unit 10 will take whatever action is required according to these policies.
A16. If there are no predefined procedures, the malware detection unit 10 prompts the user to select what action they would like to take regarding the suspected malware. For example, the malware detection unit 10 could request the user's permission to delete the code or perform some other action to disinfect their computer.

When the analysis unit has analysed a number of samples it may, for example, develop malware detection logic that requires a combination of bytestring types, specific bytestrings and/or bytestring metadata be present within the in-memory image of a program in order to identify that program as potential malware. The malware detection unit at a client computer can then emulate a program and scan it's in-memory image for the combination of bytestrings and/or metadata defined by the malware detection logic.

As an alternative to the process outlined above, a client computer 3 can execute some target code in an emulated environment, extract any bytestrings and associated metadata and send this information to the anti-virus server 1. The anti-virus sever 1 would then apply the malware detection logic to this information and return the result, and possibly any disinfection procedures or other relevant information, to the client computer 3. Furthermore, whilst the process outlined above relates to performing a malware scan of a program in an emulated environment, the method could equally be used to scan the actual memory of a computer when attempting to disinfect/clean-up an already infected computer.

The memory dumps taken from the emulated environment, by both the malware analysis unit 5 of the server 1 and the malware detection unit 10 of a computer 3, are not simply the representation of the code in the memory, but also includes the heap and stack. This is important as, whilst malware authors generally focus on obfuscating the disk image of the malware code, they sometimes also obfuscate the in-memory image. For example, human-readable strings may be separately encrypted in the in-memory image but must be decrypted and stored in the heap when accessed.

Malware very commonly writes bytestrings into on-disk files such as its log file, config file, or system files. These bytestrings can also be extracted and used to develop the malware detection logic. However, the metadata associated with such a bytestring should include an indication as to whether or not the target/sample code wrote the bytestring to the file or read it from a file created by another program on the system.

Some malware can also write into the memory of other processes. Therefore, if bytestrings were only to be extracted from the memory of the actual malware process, something particularly relevant might be missed in the analysis. To counter this, WriteProcessMemory or other such memory injection functions should be monitored, and bytestrings that are written to other processes should be extracted. The metadata associated with such bytestrings should also include information about the injection type used and the target process.

It is also important that a number of memory dumps are collected during the runtime of the code to capture all of the information, in particular that in the heap. As such, the point (i.e. the time or event) at which a bytestring occurs may also be useful metadata that can be used to develop the malware detection logic. Furthermore, it is preferable that memory dumps are taken on-the-fly, as bytestrings appear, to prevent them from being lost if they are overwritten or reused before they can be extracted. In addition, if a bytestring is extracted and later that bytestring is overwritten or the memory allocated to that bytestring is de-allocated, then the fact that the bytestring was overwritten or the memory space de-allocated is recorded as metadata associated with that bytestring, and used for analysis and/or detection of potential malware.

There are a variety of bytestring types that can commonly be found within the in-memory image of a malware program, and it is these bytestrings in particular that the malware analysis unit 5 is likely to be able to use to develop the malware detection logic. For example, these common bytestring types can include but are not limited to:
URLs, particularly those of sites related to existing malware, and those of interest to the perpetrators of the malware such as banking websites etc;
email addresses;
strings related to botnet command channels, such as those of the Internet Relay Chat (IRC) communication protocol;
strings related to spamming, such as “MAIL TO:”;
profanity;
strings in languages used in countries that are known to be sources of significant quantities of malware;
names of anti-virus companies or strings related to shutting down antivirus or firewall products;
mutex (mutual exclusion) names used by malware families;
memory structures used by malware; and
debug information (.pdb path).

In addition to human-readable bytestrings, such as those listed above, there may be bytestrings indicative of memory structures allocated by malware. For example, if malware assembles network packets in memory before sending them (i.e. to other victims or to control servers) or if malware parses configurations received from control servers, then there can be invariant bytestrings in heap memory that may indicate the presence of malware. It is bytestrings such as these that may be flagged or given additional weighting that is to be taken into account when generating the malware detection logic.

The metadata associated with a bytestring can, for example, include:
the location of the bytestring in the memory of the emulated environment (i.e. its address, module name, heap or stack);
the string in its encrypted (i.e. XOR, ROT13 etc) or plaintext form;
the encoding of the bytestring (i.e. Unicode, ASCII etc);
the point at which the bytestring occurs in the memory (i.e. the time or event at which the bytestring occurs);
whether the bytestring was overwritten or the allocated memory de-allocated;
the number of memory accesses to the bytestring;
the location of the function that created the string; or
whether the bytestring was supplied as a parameter to an OS function call that shows output to a user (i.e. a message box function).

The analysis can also make use of bytestrings that are not part of the malware code itself but that are specific to the local environment, such as the name or email address of the user, or IP address of the computer. It is not uncommon for malware to collect this sort of data in order to provide it to some malware control server or the like. Similarly, bytestrings in documents or entered by the user into password fields or browser address bars often end up in the memory of a running malware process. By using decoy bytestrings in documents or when imitating user actions within the emulated environment, the presence of these decoys within the memory of a running process can be located and may well be indicative of a malware process spying on a user. Such bytestrings are therefore also extremely useful when performing malware analysis and developing malware detection logic. Any decoy bytestrings extracted from the in memory image could be tagged as a “decoy” in their metadata, together with the inclusion of their location information.

It is not necessary to use all extracted strings in developing the malware detection logic. As such, it is preferable to provide a “white list” of bytestrings that are not of interest for the purpose of detecting malware. For example, this white list could include bytestrings that are common to both malware and non-malicious code, or at least those bytestrings that appear in both almost as frequently, such as those that typically come from operating system libraries used by programs or that are created by compiler stubs. Bytestrings extracted from the in-memory image of a sample or target and that also appear on the white list can then be filtered out, and any analysis is then performed on those remaining bytestrings.

Alternatively, feature selection (also known as variable reduction) techniques can be used to improve performance and accuracy. For example, a straightforward feature selection method is to use a scoring algorithm, such as the Fisher scoring algorithm. The difference between the feature, in this case a bytestring, and training sets of bytestrings associated with both malware and benign code is calculated. If the score is very small, the string does not provide much value in terms of separating between malicious and clean strings and can be excluded from any further analysis.

In addition, both malware and clean programs often have pseudo-random or changing content in memory. This content is not significant for malware detection and can possibly skew the classification. In order to overcome this, these randomly changing bytestrings can be detected by running the sample or target code in an emulator several times, each time in a different environment or using different parameters. Any bytestrings that appears to be random can either be disregarded or can be tagged as “random” in the associated metadata.

It is possible that some malware code may be in the form of a dynamic link library (DLL) or may inject a DLL into another host process, such that all strings written by that process should be extracted. However, bytestrings written by a benign host process will not be of interest when developing malware detection logic. As such, it is preferable that only those bytestrings written by a function of the sample/target DLL or by a function of a benign process called by the sample/target code are taken into account when developing the malware detection logic. To achieve this only those bytestrings written when a function of the DLL under analysis is in the stack (list of functions and their child-parent, caller-callee relationships) are extracted.

Those extracted bytestrings remaining after any filtering has been performed can then be used, together with their associated metadata, to develop the heuristic malware detection logic. Most heuristics methods are based on feature extraction. The antivirus engine extracts static features, such as file size or number of sections, or dynamic features based on behaviour. Classification of the code as either malware or benign is then made based on which features the sample possesses. In more traditional heuristic methods an antivirus analyst creates either rules (e.g. if target has feature 1 and feature 2 then it is malicious) or thresholds (e.g. if target has more than 10 features it is malicious).

In the recent years there has been work to perform the classification in heuristic analysis based on machine learning. The idea in machine learning is simple, features of a set of known clean and known malicious files is extracted. A classifier equation is then automatically generated. This classifier is then used to analyze new samples. There are many different classifiers that can be used for this, but the basic idea is always the same.

As such, the extracted bytestrings are used to train machine learning or artificial intelligence algorithms to develop the heuristic logic for classifying some target code either as clean or as potential malware. The use of artificial intelligence or machine learning techniques is beneficial compared to manually created heuristics since they can be created automatically and quickly. This is especially important as the appearance and/or characteristics of both malware and clean programs are constantly changing. Furthermore, creating rules manually also requires a lot of expertise. Using appropriate artificial intelligence or machine learning techniques an analyst only need maintain a collection of malware and clean files, and add or remove files that are subsequently identified as false positives or false negatives. By constantly providing new data, the algorithms/logic developed using artificial intelligence or machine learning techniques can be refined and updated continuously to be aware of new malware trends.

Some examples of artificial intelligence or machine learning techniques that can be used include:
Bayesian logic/networks: A joint probability function that can answer question such as “what is the probability of a sample being malware if it has both features 1 and 2”.
Bloom filters: A probabilistic data structure. Used to test if an element (e.g. a sample) is a member of a set (e.g. “set of all malware”).
Artificial Neural Networks: A mathematical model consisting of artificial neurons and connections between them. During learning the weights of the neuron inputs are updated.
Self-organizing maps: A type of artificial neural network that produces a low-dimensional view of the input space of the training samples.
Decision trees: A tree where nodes are features and leaves are classifications.
Support Vector Machines: Training data sets are considered to be two sets of vectors in an n-dimensional space. The classification is performed by calculating a hyperplane that can separate the two sets.

It will be appreciated by the person of skill in the art that various modifications may be made to the above described embodiments without departing from the scope of the present invention. For example, the method described above could also be used to analyse and detect potential document exploits, which take advantage of an error, bug or glitch in an application in order to infect a device, and script malware. In order to do so the emulated environment would be required to have an application for opening the document or for running the script. In the case of exploits the application needs to be vulnerable to the particular exploit (i.e. not a version of the application that has been updated and/or patched to correct the bug). The bytestrings in the memory of the emulate computer system that are generated by the application when opening samples of benign and malicious documents or running malicious and harmless scripts are extracted and analysed to generate the malware detection logic.

1. A method of detecting potential malware, the method comprising:
at a server, receiving a plurality of code samples, the code samples including at least one code sample known to be malware and at least one code sample known to be legitimate, executing each of the code samples in an emulated computer system, extracting bytestrings from any changes in the memory of the emulated computer system that result from the execution of each sample, using the extracted bytestrings to determine one or more rules for differentiating between malware and legitimate code, and sending the rule(s) to one or more client computers; and
at the one of more client computers, for a given target code, executing the target code in an emulated computer system, extracting bytestrings from any changes in the memory of the emulated computer system that result from the execution of the target code, and applying the rule(s) received from the server to the extracted bytestrings to determine if the target code is potential malware.

2. A method as claimed in claim 1, and further comprising:
at the server, storing the one or more rules, receiving an additional code sample, executing the additional code sample in an emulated computer system, extracting bytestrings from any changes in the memory of the emulated computer system that result from the execution of the additional code sample, using the extracted bytestrings to update the one or more stored rules, and sending the updated rules to the one of more client computers.

3. A method as claimed in claim 1, and further comprising:
at the server, gathering metadata associated with said extracted bytestrings, and using said metadata together with said extracted bytestrings to determine the one or more rules for differentiating between malware and legitimate code.

4. A method as claimed in claim 3, and further comprising:
at the one or more client computers, gathering metadata associated with said extracted bytestrings, and applying the rules received from the server to said bytestrings and associated metadata.

5. A method as claimed in claim 3, wherein the metadata comprises one or more of:
the location of a bytestring in the memory;
the string in its encrypted or plaintext form;
the encoding of the bytestring;
the time or event at which the bytestring occurred;
the number of memory accesses to the bytestring;
the location of the function that created the bytestring;
the memory injection type used and the target process;
whether the bytestring was overwritten or the allocated memory de-allocated.

5. (canceled)

6. A method as claimed in claim 1, wherein the bytestrings extracted from the memory of the emulated computer system includes bytestrings extracted from the heap and the stack sections of the memory.

7. A method as claimed in claim 1, and further comprising:
at the server, extracting bytestrings written into files that are created on the disk of the emulated computer system by the sample code during execution in the emulated computer system.

8. A method as claimed in claim 7, and further comprising:
at the one of more client computers, extracting bytestrings written into files that are created on the disk of the emulated computer system by the target code during execution in the emulated computer system.

9. A method as claimed in claim 1, and further comprising:
using decoy bytestrings in documents and when imitating user actions within the emulated environment, and identifying any decoy bytestrings extracted from the memory during execution of the sample or target code in the emulated computer system.

10. A method as claimed in claim 1, and further comprising:
at the server, prior to determining one or more rules for differentiating between malware and legitimate code, removing from the extracted bytestrings any bytestrings that match those contained within a list of insignificant bytestrings.

11. A method as claimed in claim 1, and further comprising:
at the server, prior to determining one or more rules for differentiating between malware and legitimate code, measuring the difference between each of the extracted bytestrings and bytestrings that have previously been identified as being associated with both malware and legitimate code, and removing from the extracted bytestrings any bytestrings for which this difference does not exceed a threshold.

12. A method as claimed in claim 1, and further comprising:
at the one of more client computers, prior to applying the rule(s) received from the server, removing from the extracted bytestrings any bytestrings that match those contained within a list of insignificant bytestrings.

13. A method as claimed in claim 1, wherein the step of using the extracted bytestrings to determine one or more rules for differentiating between malware and legitimate code comprises:
at the server, providing the bytestrings to one or more artificial intelligence algorithms, the artificial intelligence algorithm(s) being configured to generate the one or more rules for differentiating between malware and legitimate code.

14. A method of detecting potential malware, the method comprising:
at a server, receiving a plurality of code samples, the code samples including at least one code sample known to be malware and at least one code sample known to be legitimate, executing each of the code samples in an emulated computer system, extracting bytestrings from changes in the memory of the emulated computer system that result from the execution of each sample, using the extracted bytestrings to determine one or more rules for differentiating between malware and legitimate code;
at one of more client computers, for a given target code, executing the target code in an emulated computer system, extracting bytestrings from changes in the memory of the emulated computer system that result from the execution of the target code, and sending the extracted bytestrings to the server; and
at the server, for each of the one of more client computers applying the rule(s) to the extracted bytestrings received from the client computer to determine if the target code is potential malware and sending the result to the client computer.

15. A server for use in provisioning a malware detection service, the server comprising:
a receiver for receiving a plurality of code samples, the code samples including at least one sample known to be malware and at least one code sample known to be legitimate;
a processor for executing each of the code samples in an emulated computer system, and for extracting bytestrings from changes in the memory of the emulated computer system that result from the execution of each sample;
an analysis unit for using the bytestrings extracted from the or each code sample to determine one or more rules for differentiating between malware and legitimate code; and
a transmitter for sending the rules to one or more client computers.

16. A server as claimed in claim 15 and comprising a database for storing the one or more rules, wherein the receiver is further arranged to receive an additional code sample, the processor is further arranged to execute the additional code sample in an emulated computer system, to extract bytestrings from changes in the memory of the emulated computer system that result from the execution of the additional code sample, the analysis unit is further arranged to use the bytestrings extracted from the additional sample to update the one or more rules stored in the database, and the transmitter is further arranged to send the updated rules to the client computer.

17. A server as claimed in claim 15, wherein the processor is further arranged to gather metadata associated with said extracted bytestrings, and the analysis unit is further arranged to use said metadata together with said extracted bytestrings to determine the one or more rules for differentiating between malware and legitimate code.

18. A server as claimed in claim 17, wherein the one or more rules comprise one or more combinations of bytestrings and/or metadata associated with bytestrings, the presence of which in the bytestrings and associated metadata extracted during execution of the target code is indicative of malware.

19. A server as claimed in claim 15, wherein the processor is further arranged to extract bytestrings from the heap and the stack sections of the memory of the emulated computer system.

20. A server as claimed in claim 15, wherein the processor is further arranged to remove, from the extracted bytestrings, any bytestrings that match those contained within a list of insignificant bytestrings.

21. A server as claimed in claim 15, wherein the analysis unit is further arranged to implement one or more artificial intelligence algorithms, the artificial intelligence algorithm(s) being configured to generate the one or more rules for differentiating between malware and legitimate code.

22. A client computer comprising:
a receiver for receiving from a server one or more rules for differentiating between malware and legitimate code;
a memory for storing the one or more rules; and
a malware detection unit for executing a target code in an emulated computer system, for extracting bytestrings from changes in the memory of the emulated computer system that result from the execution of each sample, and applying said one or more rules received from the server to the extracted bytestrings to determine if the target code is potential malware.

23. A client computer as claimed in claim 22, wherein the malware detection unit is further arranged to extract bytestrings from the heap and the stack sections of the memory of the emulated computer system.

24. A client computer as claimed in claim 22, wherein the malware detection unit is further arranged to gather metadata associated with said extracted bytestrings from the memory during execution of the target code, and to apply the rules received from the server to said bytestrings and their associated metadata.

25. A client computer as claimed in claim 22, wherein the malware detection unit is further arranged to remove, from the extracted bytestrings, any bytestrings that match those contained within a list of insignificant bytestrings, prior to applying the rule(s) received from the server.

26. A method as claimed in claim 3, wherein the one or more rules comprise one or more combinations of bytestrings and/or metadata associated with bytestrings, the presence of which in the bytestrings and associated metadata extracted during execution of the target code is indicative of malware.
